(19) United States
(12) Patent Application Publication
(10) Pub. No.: US 2004/0261823 A1
(43) Pub. Date: Dec. 30, 2004

(54) Method and apparatus for removing a target layer from a substrate using reactive gases

(75) Inventor: John M. de Larios, Palo Alto, CA (US)

Correspondence Address: MARTINE & PENILLA, LLP, 710 LAKEWAY DRIVE, SUITE 170, SUNNYVALE, CA, 94085, US

(73) Assignee: LAM RESEARCH CORPORATION, FREMONT, CA

(21) Appl. No.: 10/608,871

(22) Filed: Jun. 27, 2003

(51) Int. Cl. B08B 5/00

(52) U.S. Cl. 134/31; 134/34; 134/36; 134/94.1

(57) ABSTRACT

A system and method for removing a layer from a substrate surface is provided. The method includes providing at least one encapsulating transport, where the encapsulating transport contains at least some reactive gas. At least one encapsulating transport is applied to the layer, and the layer is a chemically reactive layer. The encapsulating transport ruptures on the chemically reactive layer and releases the reactive gas in combination with a reaction inducing agent onto the chemically reactive layer to facilitate removal of the layer from the substrate surface.

### BACKGROUND OF THE INVENTION

1. Field of the Invention

The present invention relates to semiconductor manufacturing and, more particularly, to a method of delivering reactive gases for cleaning silicon wafer surfaces.

2. Description of the Related Art

The process of manufacturing electronic devices on silicon wafers involves a complex process of depositing and removing a number of layers. Such layers, for example, include dielectric layers, metal layers, polysilicon layers and others layers, all of which may be removed either entirely or partially during patterning steps. Typically, patterning of layer materials includes the application of an organic photoresist onto the silicon wafer. Then, the photoresist is patterned before conducting a plasma etch. After the plasma chemistry etches the target material, the silicon wafer needs to be cleaned to remove the organic photoresist. If the organic photoresist is not removed, the organic photoresist will contaminate the silicon wafer resulting in damage to the electronic devices on the silicon wafer. As such, cleaning operations define a very critical step that is repeated many times throughout the processing cycles that define the many layers of a semiconductor device.

One method to remove organic photoresist is to use ozone (O₃). Ozone is placed in contact with the organic photoresist. A reaction therefore occurs between the ozone and the organic photoresist, thus oxidizing the organic photoresist into C0₂. This reaction therefore enables the removal of the organic photoresist contaminants. In particular, the oxidization reaction requires H₂O. The oxidization rate depends on a combination of solubility of ozone in deionized water (DIW) and temperature. As is known, ozone is highly soluble at low temperatures, but the reaction rate is slow. For high temperatures, ozone has a high reaction rate, however, it is less soluble.

U.S. Pat. No. 5,464,480 to Matthews discloses a silicon wafer cleaning process that immerses batches of silicon wafers in a chilled aqueous solution that is highly saturated with ozone. As a result of the high saturation, there is a high level of oxidization with the organic photoresist. Immersing the whole silicon wafer in the aqueous solution also insures that the whole silicon wafer surface is exposed to the aqueous solution. Although low temperatures raise the solubility limit of ozone, the low temperatures also slow down oxidization rates, thereby resulting in longer cleaning times when compared to a process using higher temperatures. Moreover, the process is terribly inefficient with the use of water because the process uses gallons of water to remove only a very minute amount of contaminant.

U.S. Pat. No. 6,267,125 to Bergman et al. discloses a silicon wafer cleaning process that sprays DIW onto a wafer surface and rotates the wafer. The centrifugal force of the rotation spreads or disperses the DIW into a very thin layer. The process then introduces a high concentration of ozone onto the silicon wafer. Since ozone has to diffuse through a very thin layer of DIW, the ozone almost immediately reacts with and oxidizes the organic photoresist. In the case of a thick layer of DIW, the removal of the photoresist takes longer because the low solubility of the ozone limits the ozone diffusion through the thick layer of water.

A difficulty with Bergman et al. is that the process sprays DIW onto the center of the silicon wafer surface and, as a result of the rotation, more DIW collects at the center than at the edge of the wafer. In other words, the rotation does not distribute DIW evenly on the silicon wafer surface. Thus, the non-uniform distribution of the DIW (e.g., thickness) results in poor and/or non-uniform removal of photoresist contaminants. This non-uniform removal occurs because in some thicker regions the reaction is slower, while in thinner coated regions the reaction is faster.

In view of the foregoing, what is needed is a semiconductor cleaning process that efficiently, uniformly and quickly delivers the maximum concentration of reactive gases onto the silicon wafer surface with minimal use of DIW.

### SUMMARY OF THE INVENTION

Broadly speaking, the present invention fills these needs by providing a system and method to remove a layer from a substrate surface. It should be appreciated that the present invention can be implemented in numerous ways, including as a process, an apparatus, a system, computer readable media, or a device. Several inventive embodiments of the present invention are described below.

One embodiment provides for a method to remove a layer from a substrate surface. The method includes providing at least one encapsulating transport where the encapsulating transport contains at least some reactive gas. At least one encapsulating transport is applied to the layer, and the layer is a chemically reactive layer. The encapsulating transport ruptures on the chemically reactive layer and releases the reactive gas onto the chemically reactive layer to facilitate removal of the layer from the substrate surface.

An alternative embodiment provides for a method to remove a layer from a substrate surface. The method mixes a reactive gas and a reaction inducing agent to generate at least one encapsulating transport and the encapsulating transport contains at least some of the reactive gas.

Thereafter, the method applies the encapsulating transport to a chemically reactive layer. The encapsulating transport ruptures on the chemically reactive layer and releases the reactive gas onto the chemically reactive layer to facilitate removal of the layer from the substrate surface.

Another embodiment includes an apparatus for removing a layer from a substrate surface. The apparatus includes an application unit configured to receive at least one encapsulating transport. The encapsulating transport contains at least some reactive gas and the encapsulating transport can be applied to the layer. When the encapsulating transport ruptures, it causes a reaction between the layer and the reactive gas.

An alternative embodiment includes an apparatus for removing a layer from a substrate surface. The apparatus includes a reactive gas source, a reaction inducing agent source and an application unit. The application unit is configured to receive a combination of the reactive gas obtained from the reactive gas source and the reaction inducing agent obtained from the reaction inducing agent source. Furthermore, the apparatus produces at least one encapsulating transport containing at least some of the reactive gas. The encapsulating transport can be applied to the layer, and when the encapsulating transport ruptures, it causes a reaction between the layer and the reactive gas.

### BRIEF DESCRIPTION OF THE DRAWINGS

The present invention will be readily understood by the following detailed description in conjunction with the accompanying drawings, and like reference numerals designate like structural elements.

FIG. 1 shows a number of encapsulating transports defining foam in accordance to one embodiment of the present invention.

FIG. 2A shows a detailed or magnified view of the interface between two encapsulating transports in accordance to one embodiment of the present invention.

FIG. 2B shows an encapsulating transport rupturing on an organic material in accordance to one embodiment of the present invention.

FIGS. 3A, 3B, 3C and 3D show various methods to generate foam in accordance to various embodiments of the present invention.

FIGS. 4A, 4B, 4C, 4D and 4E show various embodiments to apply foam to the organic material layer in accordance to various embodiments of the present invention.

FIG. 5 shows a proximity head to remove the organic material layer from the substrate surface in accordance to one embodiment of the present invention.

FIG. 6 is a flowchart of the method operations of removing a layer from a substrate surface in accordance with one embodiment of the present invention.

### DETAILED DESCRIPTION OF THE EXEMPLARY EMBODIMENTS

An invention is disclosed for a method and apparatus for facilitating the removal of layer materials from a substrate. In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

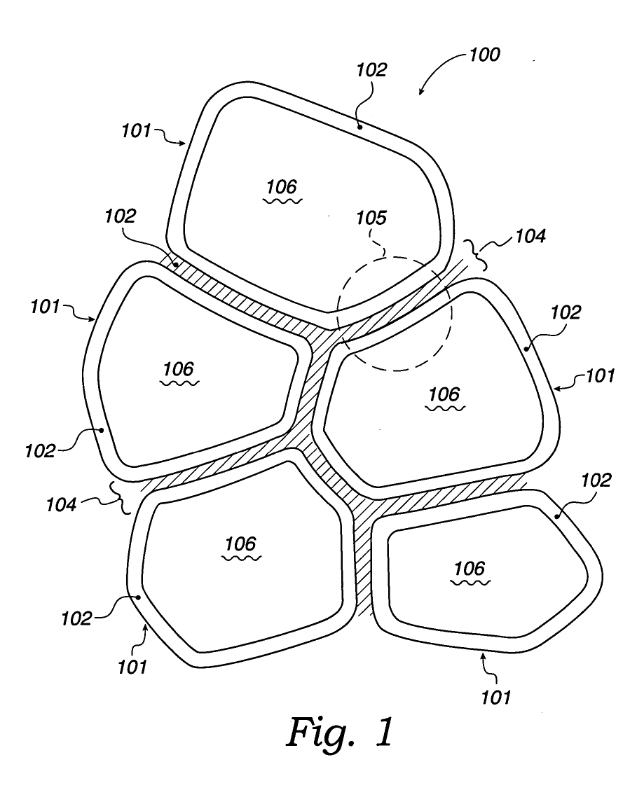

FIG. 1 illustrates a number of encapsulating transports 101 defining foam 100. As used herein, one or more of the encapsulating transports 101 can be said to define a bubble or foam, depending on their arrangement with respect to one another. In the illustration of FIG. 1, a number of encapsulating transports 101 are collectively joined in such a manner to define them as the foam 100. Of course, if one or more encapsulating transport 101 separates from the foam 100, each encapsulating transport 101 can be considered a bubble.

In accordance with one embodiment of the invention, an encapsulating transport 101 is a two-phase system in which a reactive gas 106 is enclosed by a reaction inducing agent 102. The reaction inducing agent 102 defines a membrane or film that holds and surrounds the reactive gas 106. The reactive gas 106 is preferably a gas or any combination of gases that will chemically react or will facilitate a chemical reaction when placed in direct contact with another material. Examples of reactive gases 106 include gasses that react with contamination such as ozone (O₃), oxygen (O₂), hydrochloric acid (HCl) and hydrofluoric acid (HF) and non-reactive gasses such as nitrogen (N₂) and argon (Ar). The reactive gas 106 may also include any combination of gases such as ozone (O₃) and nitrogen (N₂); ozone (O₃) and argon (Ar); ozone (O₃), oxygen (O₂) and nitrogen (N₂); ozone (O₃), oxygen (O₂) and argon (Ar); ozone (O₃), oxygen (O₂), nitrogen (N₂) and argon (Ar); oxygen (O₂) and argon (Ar); oxygen (O₂) and nitrogen (N₂); and oxygen (O₂), argon (Ar) and nitrogen (N₂). An embodiment of the present invention uses ozone as the reactive gas 106 because ozone, when combined with water (H₂O), will chemically react with an organic material. In one embodiment, the organic material may be an organic photoresist material, which is commonly used in semiconductor photolithography operations. In another embodiment, nitrogen can also be combined with ozone to increase the concentration of ozone in the encapsulating transport 101.

In one embodiment, the reaction inducing agent 102 is a liquid (e.g., water or DIW ) that will chemically react or will facilitate a chemical reaction when placed in direct contact with another material. The reaction inducing agent 102 may be an aqueous solution of DIW containing suitable cleaning fluids or a semiaqueous solution containing suitable cleaning fluids. Examples of the reaction inducing agents include water (H₂O); deionized water (DIW); water (H₂O) and the cleaning fluid; water (H₂O) and a surfactant 108; water (H₂O), the cleaning fluid and the surfactant 108; deionized water (DIW) and the surfactant 108; and the deionized water (DIW), the cleaning fluid and the surfactant 108. An embodiment of the present invention uses water as the reaction inducing agent 102 because water enables or facilitates the chemical reaction between ozone and the organic photoresist material. The reaction inducing agent 102 surrounds the reactive gas 106 and the reaction inducing agent 102 may also exist in the space between encapsulating transports 101.

As simplistically illustrated in FIG. 1, this space forms a channel 104 of finite width and the reaction inducing agent 102 flows through the channel 104. It is believed that there is very little reaction inducing agent 102 surrounding the reactive gas 106 and most reaction inducting agent 102 is found in the channel 104. However, a channel 104 does not necessarily form between two encapsulating transports 101. In such a situation, the reaction inducing agent 102 is found surrounding the reactive gases 106. Furthermore, in various circumstances, including a process by which a freshly made foam 100 settles into equilibrium, gravity or other forces cause the reaction inducing agent 102 to drain out of the foam 100 through the channels 104.

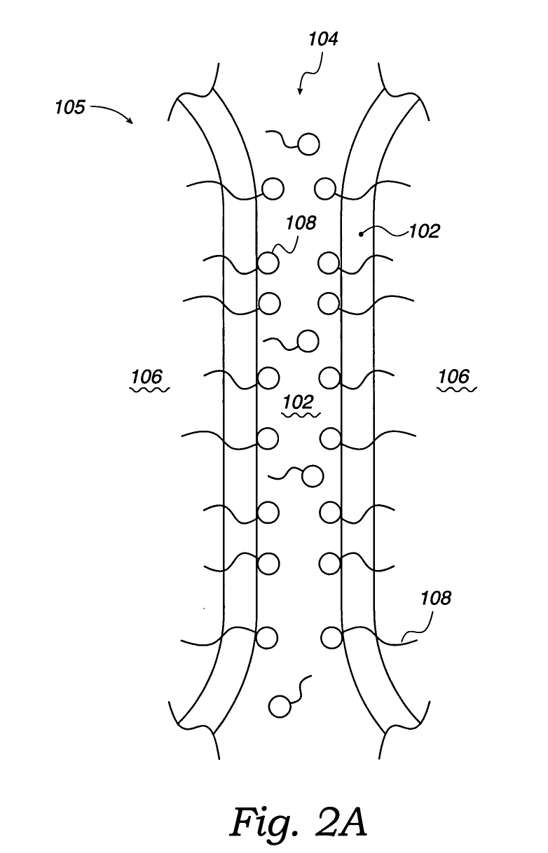

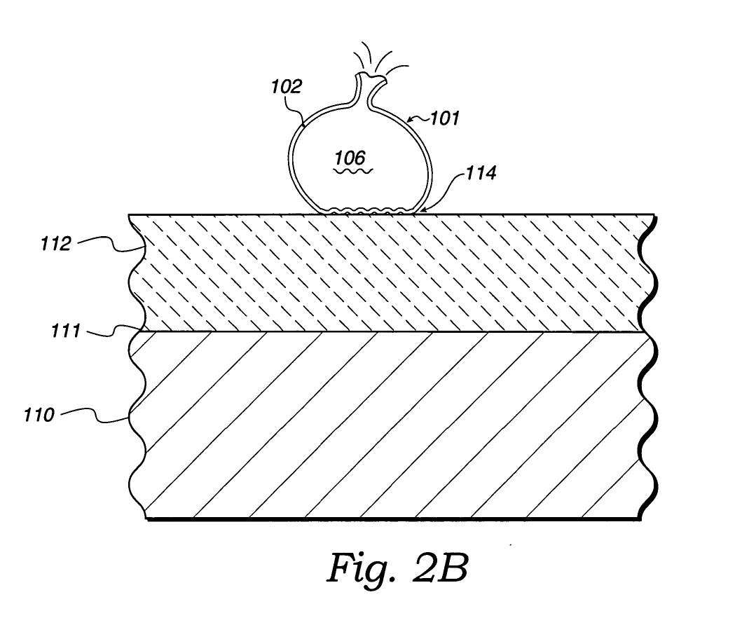

FIG. 2A illustrates a detailed or magnified view 105 of the interface between two encapsulating transports 101. The figure shows reactive gases 106 separated by a channel 104 of reaction inducing agent 102. Most foams 100 owe their existence to the presence of surfactants 108. An example of a surfactant 108 is soap which is made from fats and oils. The fats and oils are converted into fatty acids, and incorporated typically as sodium salts. Generally, the surfactants 108 reduce the surface energy or tension associated with the surface of an encapsulating transport 101. More importantly, the surfactants 108 stabilize the surface of the encapsulating transport 101 against rupture. Another popular additive is glycerol (in high concentration) to increase viscosity and hence inhibit drainage of reaction inducing agent 102 in foam 100. Commercial foam products also contain small additions of ingredients described as foam boosters which are known to enhance the performance of the surfactants 108. For more information on the physics of foam, reference may be made to a book entitled “The Physics of Foams,” by Denis Weaire and Stefan Hutzler, copyright date 1999, and which is herein incorporated by reference.

FIG. 2B shows an embodiment of the present invention illustrating an encapsulating transport 101 rupturing on an organic material layer 112. This embodiment uses organic photoresist as the organic material because patterning a substrate 110 includes the application of organic photoresist onto the substrate 110. The substrate 110 in this embodiment is a silicon wafer. However, the substrate 110 is not limited to silicon wafers. Organic photoresist can be applied to a variety of substrate layers for patterning. Examples of substrate layers include dielectric layers, metal layers, polysilicon layers and other layers, all of which may be removed either entirely or partially during patterning. The organic material may also originate from a photoresist that has been processed with a suitable dry strip process or a suitable wet strip process.

Most encapsulating transports 101 and foams 100 have a finite lifespan. Usually, the exposed surface of the encapsulating transport 101 ruptures to end the life of the encapsulating transport 101. Many factors can be adduced to account for the rupture. Drainage of reaction inducing agents 102 is important in reducing the thickness of encapsulating transports 101. Evaporation may reduce the thickness further. Additionally, surfactant concentration may be inadequate, dust may impact on the encapsulating transports 101, or impurities and additives may promote their instability. The reactive gas 106 also may react with the surface of the encapsulating transport 101 to limit the foam's lifespan.

In one embodiment, when the encapsulating transport 101 ruptures, the rupture releases the reactive gas 106 and the reaction inducing agent 102 and places them in direct contact with the organic material layer 112 at the interface 114 between the encapsulating transport 101 and the organic material layer 112. By placing the reactive gas 106 and the reaction inducing agent 102 in direct contact with the organic material layer 112, a chemical reaction between the reactive gas 106, the reaction inducing agent 102 and the organic material layer 112 occurs thereby facilitating the removal of the organic material layer 112 from the substrate surface 111. Finally, placing the reaction inducing agent 102 in direct contact with the organic material layer 112 does not require the encapsulating transport 101 to rupture. As discussed above, drainage of the reaction inducing agent 102 from a foam 100 also places the reaction inducing agent 102 in contact with the organic material layer 112.

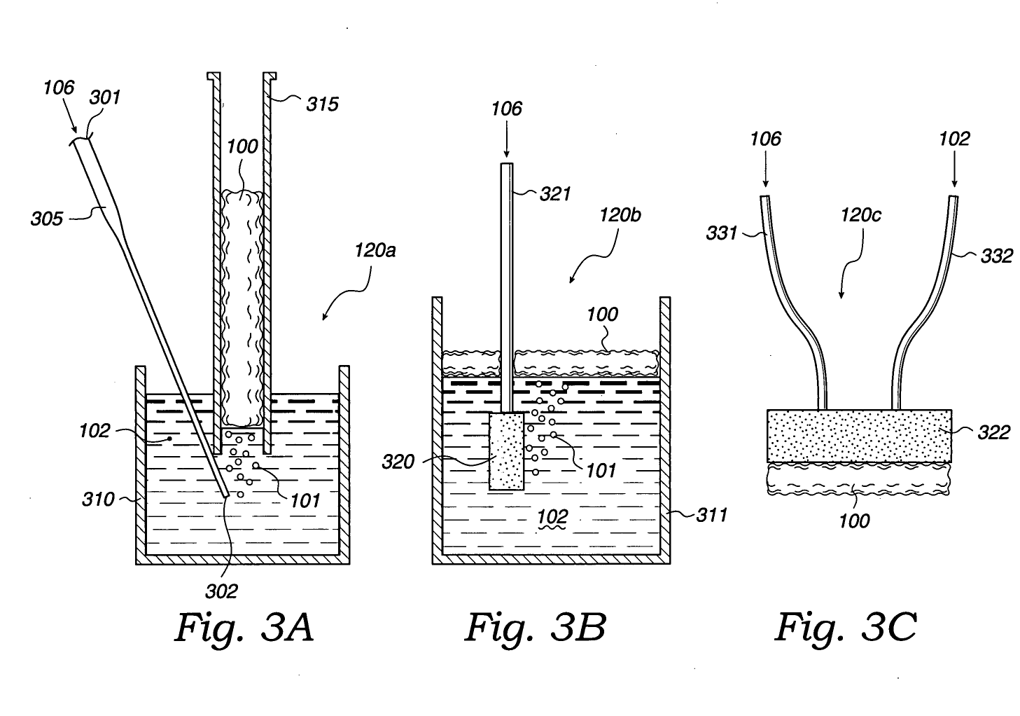

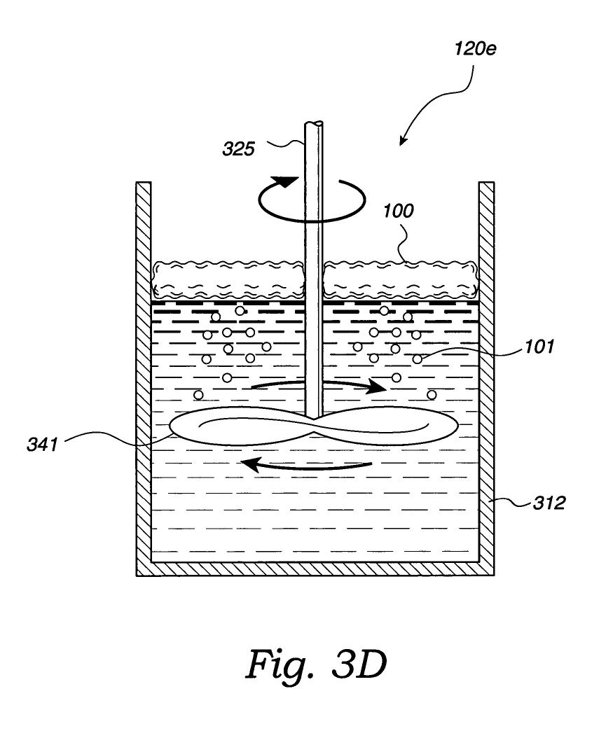

Although there are many ways to generate foam 100, FIGS. 3A through 3D illustrate various exemplary methods to enable the generation. FIG. 3A illustrates one embodiment of an encapsulating transport generator 120a that includes a fine nozzle 305 partly immersed in the reaction inducing agent 102 contained in a container 310. The encapsulating transport generator 120a generates encapsulating transports 101 by supplying the reactive gas 106 under a constant pressure through an input end 301 of the fine nozzle 305. The supply of the reactive gas 106 generates encapsulating transports 101 at the output end 302 of the fine nozzle 305 that is immersed in the reaction inducing agent 102. The encapsulating transports 101 then float to the top of the reaction inducing agent 102. In one embodiment, another container 315 situated above the output end 302 of the fine nozzle 305 traps the encapsulating transports 101 at the top of the reaction inducing agent 102 whereby the encapsulating transports 101 combine in such a manner to define them as the foam 100.

FIG. 3B illustrates another embodiment of an encapsulating transport generator 120b that includes a sparger 320 immersed in the reaction inducing agent 102 contained in a container 311. The encapsulating transport generator 120b generates encapsulating transports 101 by supplying the reactive gas 106 under pressure through an input conduit 321 connected to the sparger 320. The reactive gas 106 diffuse through the sparger 320 and into the reaction inducing agent 102 to form encapsulating transports 101. The encapsulating transports 101 then float to the top of the reaction inducing agent 102 and combine in such a manner to define them as the foam 100. For more information on spargers, reference may be made to U.S. Pat. Nos. 5,858,283 and 3,978,176 to Burris and Voegeli respectively, which are herein incorporated by reference.

FIG. 3C illustrates another embodiment of an encapsulating transport generator 120c that includes a sparger 322 with a reactive gas input conduit 331 and a reaction inducing agent input conduit 332. The encapsulating transport generator 120c generates foam 100 by supplying the reactive gas 106 and the reaction inducing agent 102 through the conduits 331, 332 under pressure into the sparger 322. The reactive gas 106 and the reaction inducing agent 102 mix within the sparger 322 in such a manner to generate foam 100.

FIG. 3D illustrates another embodiment of an encapsulating transport generator 120e that includes a mechanical agitator 325 in the form of a rotating shaft with radiating blades 341. The blades 341 are immersed in the reaction inducing agent 102 saturated with the reactive gas 106. The rotating radiating blades 341 rotate to agitate the reaction inducing agent 102 saturated with the reactive gas 106 thereby generating encapsulating transports 101. The encapsulating transports 101 float to the top of the reaction inducing agent 102 saturated with the reactive gas 106 and combine in such a manner to define them as the foam 100.

Additionally, in other embodiments, the mechanical agitator 325 may not necessarily be configured as radiating blades but may be any suitable configuration, shape and/or size such as, for example, a stick, a bar, a tube, a plate, etc., as long as the mechanical agitator 325 is configured in a manner that would agitate the reaction inducing agent 102 saturated with the reactive gas 106. In another embodiment, agitation of the reaction inducing agent 102 saturated with the reactive gas 106 is done without a mechanical agitator 325. Instead, agitation is be done by shaking or beating the reaction inducing agent 102 saturated with the reactive gas 106 to generate encapsulating transports 101.

There are various additional methods and apparatuses to generate foam 100. For example, nucleation of encapsulating transports 101 in the reaction inducing agent 102 saturated with the reactive gas 106 also generates foam 100. For additional examples of foam generation, U.S. Pat. No. 6,276,459 discloses a foam generating device that uses compressed gas and liquid which is herein incorporated by reference. Additionally, U.S. Pat. No. 5,900,191 discloses another foam producing apparatus and method which is herein incorporated by reference.

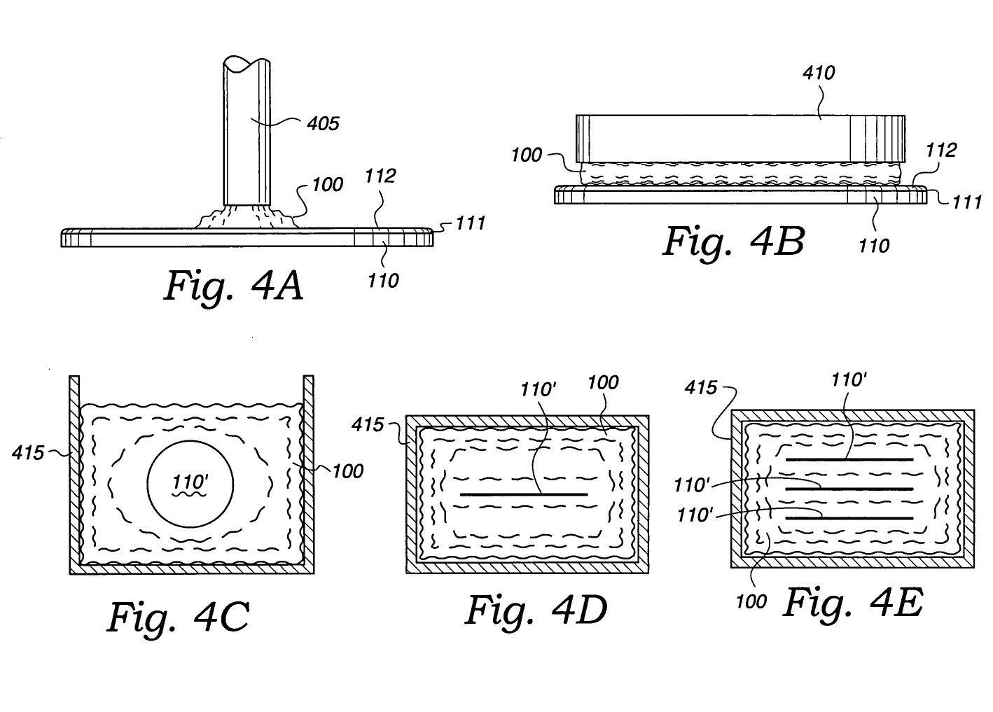

FIGS. 4A through 4E illustrate various exemplary embodiments to apply foam 100 to the organic material layer 112. Of course, other embodiments are envisioned, so long as the function of applying the foam 100 to the surface of an organic material layer 112 is achieved. FIG. 4A illustrates an embodiment where an applicator 405 directly applies the foam 100 on the organic material layer 112. In this embodiment, the applicator 405 is a hollow cylindrical tube used to conduct the foam 100. The applicator 405 receives the foam 100 and conducts the foam 100 onto the organic material layer 112. The application of the foam 100 on the organic material layer 112 spreads the encapsulating transports 101 across the surface of the organic material layer 112. When the encapsulating transports 101 rupture, the rupture places a combination of the reactive gas 106 and a thin layer of the reactive reducing agent 102 in direct contact with the organic material layer 112. Since the reactive gas 106 has to diffuse through a very thin layer of reaction inducing agent 102, the reactive gas 106 almost immediately reacts with the organic material layer 112, thereby facilitating the removal of the organic material layer 112 from the substrate surface 111. Furthermore, since the thickness of the reaction inducing agent layer is uniform across the surface of the organic material layer 112, the removal of the organic material is believed to be uniform.

In one embodiment, the applicator 405, as illustrated in FIG. 4A, may move in a linear fashion from a center portion of the substrate 110 to the edge of the substrate 110. It should be appreciated that other embodiments may be utilized where the applicator 405 moves in a linear fashion from one edge of the substrate 110 to another diametrically opposite edge of the substrate 110, or other non-linear movements may be utilized such as, for example, in a radical motion, in a circular motion, in a spiral motion, in a zig-zag motion, etc.

Additionally, the applicator 405 may not necessarily be a cylindrical tube in configuration but may be any suitable configuration, shape and/or size such as, for example, a manifold, a circular puck, a bar, a square, an oval puck, a plate, etc., as long as the applicator 405 is configured in a manner that would enable the application of foam 100. FIG. 4B shows another example of an embodiment wherein the applicator 410 is in the shape of a circular puck. The width of the applicator 410 spans the width of the substrate 110 but the applicator 410 may be varied to any suitable size depending on the application desired. In one embodiment, the applicator 410 receives foam 100 and uniformly applies foam 100 to the entire surface of the organic material layer 112 in one application.

FIG. 4C illustrates another embodiment whereby the foam 100 is applied to the organic material layer 112 by immersing the substrate 110 in the foam 100. FIG. 4C illustrates a side cutout view of the substrate 110 in the form of a silicon wafer 110′ completely immersed in the foam 100 contained in a container 415. FIG. 4D illustrates a top view of the silicon wafer immersed in the foam 100. Immersing the whole silicon wafer 110′ in foam 100 exposes the entire surface of the organic material layer 112 to the foam 100. As discussed above, when the encapsulating transports 101 rupture, the rupture places the reactive gas 106 and the reaction inducing agent 102 in direct contact with the organic material to facilitate the removal of the organic material layer 112 from the silicon wafer 110′. Since this embodiment exposes the entire surface of the organic material layer 112 to a large amount of foam 100, the immersion thoroughly and uniformly removes the organic material layer 112 from the silicon wafer 110′.

FIG. 4E illustrates another embodiment whereby more than one silicon wafer 110′ are immersed in the foam 100. FIG. 4E illustrates a top view of three silicon wafers 110′ immersed in the foam 100. Immersing a batch of silicon wafers 110′ in the foam 100 cleans more silicon wafers 110′ at one time than immersing one silicon wafer 110′ in the foam 100, thereby increasing efficiency.

In other embodiments, the placement of the silicon wafer 110′ in the container 415 of foam 100 can be in any orientation or place as long as some of the surface of the organic material layer 112 is in direct contact with the foam 100. Additionally, in another embodiment, the container 415 may not necessarily be a rectangular box in configuration but may be any suitable configuration, shape and/or size as long as the container is configured in a manner to hold foam 100.

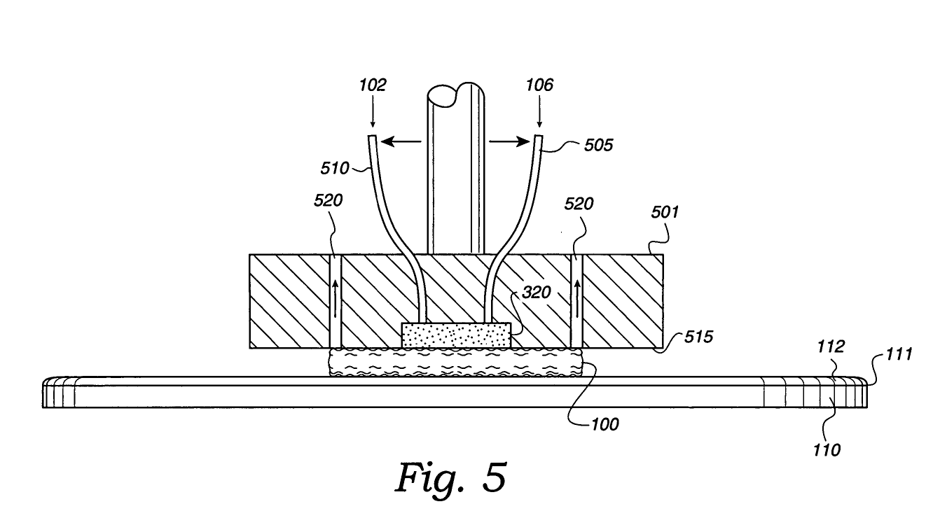

As illustrated in FIG. 5, another embodiment of the present invention uses a proximity head 501 to remove the organic material layer 112 from the substrate surface 111. The proximity head 501 includes a head having a head surface 515 where the head surface 515 is proximate to the organic material layer 112. In one embodiment, a sparger 320 is part of the proximity head 501 whereby the sparger 320 is connected to a reaction inducing agent input conduit 510 and a reactive gas input conduit 505. The reactive gas 106 and reaction inducing agent 102 are supplied under pressure into the sparger 320 through the reactive gas conduit 505 and the reaction input conduit 510, respectively. The reactive gas 106 and the reaction inducing agent 102 mix within the sparger 320 in such a manner to generate foam 100 between the proximity head 501 and the surface of the organic material layer 112. Additionally, in other embodiments, as seen in FIGS. 4A and 4B, the sparger 320 may not be part of the proximity head 501. In this embodiment, the proximity head does not generate foam 100 and may instead have any suitable number of inlet conduits to supply foam 100 wherein the foam 100 is generated by other methods or apparatuses.

In another embodiment, the proximity head 501 may be configured to have at least one removing conduit 520 configured to output liquids, gases, foams and/or organic materials from a region between the wafer and the proximity head 501 by applying vacuum (also known as a vacuum outlet). It should be understood that any suitable number of spargers, removing conduits and/or foam inlet conduits may be utilized depending on the configuration of the apparatus. In still other embodiments, the proximity head 501 can include other inlets for delivering other fluids, such as, air, isopropyl alcohol (IPA), DI water, chemicals, etc. Additionally, other outlets may also be included, depending on the application. Thus, for simplicity, only one set of removing conduits 520 are shown.

Additionally, the proximity head 501 may not necessarily be a “head” in configuration but may be any suitable configuration, shape and/or size such as, for example, a manifold, a circular puck, a bar, a square, an oval puck, a tube, plate, etc., as long as the proximity may be configured in a manner that would enable the application of foam 100. In one embodiment, the proximity head 501 may be a type of circular puck as illustrated in FIG. 5. The size of the proximity head 501 may be varied to any suitable size depending on the application desired.

In the embodiment shown, the proximity head 501 may move in a linear fashion from a center portion of the substrate 110 to the edge of the substrate 110. It should be appreciated that other embodiments may be utilized where the proximity head 501 moves in a linear fashion from one edge of the substrate 110 to another diametrically opposite edge of the substrate 110, or other non-linear movements may be utilized such as, for example, in a radical motion, in a circular motion, in a spiral motion, in a zig-zag motion, etc. The motion may also be any suitable specified motion profile as desired by a user. In another embodiment, the substrate 110 may be rotated and the proximity head 501 moved in a linear fashion so the proximity head 501 may process all portions of the substrate 110. It should also be understood that other embodiments may be utilized where the substrate 110 is not rotated but the proximity head 501 is configured to move over the substrate 110 in a fashion that enables processing of all portions of the substrate 110. In addition, the proximity head 501 may be utilized to apply foam 100 to any shape and size of substrates 110 as for example, 200 mm wafers, 300 mm wafers, flat panels, etc.

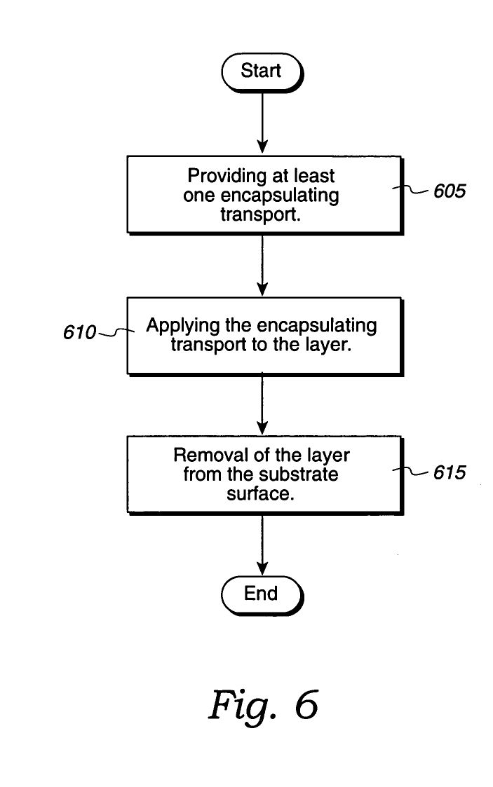

FIG. 6 is a block diagram showing exemplary functional blocks illustrating an embodiment of a method to remove the organic material layer 112 from the substrate surface 111. First, in operation 605, the method provides at least one encapsulating transport 101. As discussed above, there are various methods and apparatuses to generate encapsulating transports 101 and foam 100. In operation 610, the method applies the encapsulating transports 101 to the organic material layer 112. In operation 615, when the encapsulating transports 101 rupture on the organic material layer 112, the rupture places a combination of the reactive gas 106 and a thin film of the reaction inducing agent 102 in direct contact with the organic material layer 112, thereby facilitating the removal of the organic material layer 112 from the substrate 110.

1. A method for removing a layer from a substrate surface, comprising:
providing at least one encapsulating transport, the encapsulating transport containing at least some reactive gas;
applying the at least one encapsulating transport to the layer, the layer being a chemically reactive layer; and
wherein the encapsulating transport ruptures on the chemically reactive layer and releases the reactive gas onto the chemically reactive layer to facilitate removal of the layer from the substrate surface.

2. A method for removing a layer from a substrate surface as recited in claim 1, wherein releasing the chemically reactive gas onto the chemically reactive layer places a combination of the reactive gas and a reaction inducing agent in direct contact with the chemically reactive layer.

3. A method for removing a layer from a substrate surface as recited in claim 2, wherein the reaction inducing agent is one of water (H₂O), deionized water (DIW), water (H₂O) and a cleaning fluid, water (H₂O) and a surfactant, water (H₂O) and the cleaning fluid and the surfactant, deionized water (DIW) and the cleaning fluid, deionized water (DIW) and the surfactant, and the deionized water (DIW) and the cleaning fluid and the surfactant.

4. A method for removing a layer from a substrate surface as recited in claim 1, wherein the at least one encapsulating transport is combined with other encapsulating transports to define a foam.

5. A method for removing a layer from a substrate surface as recited in claim 1, wherein the at least one encapsulating transport is a bubble.

6. A method for removing a layer from a substrate surface as recited in claim 1, wherein the chemically reactive layer is an organic material.

7. A method for removing a layer from a substrate surface as recited in claim 1, wherein the reactive gas is one of ozone (O₃), oxygen (O₂), hydrochloric acid (HCl), hydrofluoric acid (HF), nitrogen (N₂), argon (Ar), ozone (O₃) and nitrogen (N₂), ozone (O₃) and argon (Ar), ozone (O₃) and oxygen (O₂) and nitrogen (N₂), ozone (O₃) and oxygen (O₂) and argon (Ar), ozone (O₃) and oxygen (O₂) and nitrogen (N₂) and argon (Ar), oxygen (O₂) and argon (Ar), oxygen (O₂) and nitrogen (N₂), and oxygen (O₂) and argon (Ar) and nitrogen (N₂).

8. A method for removing a layer from a substrate surface as recited in claim 2, further comprising,
generating the at least one encapsulating transport.

9. A method for removing a layer from a substrate surface as recited in claim 8, wherein the generating the at least one encapsulating transport further comprising,
providing the reactive gas;
providing the reaction inducing agent; and
mixing the reactive gas and the reaction inducing agent to generate the at least one encapsulating transport, the encapsulating transport containing at least some of the reactive gas.

10. A method for removing a layer from a substrate surface as recited in claim 8, wherein the generating the at least one encapsulating transport further comprising,
providing the reactive gas;
providing the reaction inducing agent; and
mixing under pressure the reactive gas and the reaction inducing agent to generate the at least one encapsulating transport, the encapsulating transport containing at least some of the reactive gas.

11. A method for removing a layer from a substrate surface as recited in claim 8, wherein the generating the at least one encapsulating transport further comprising,
providing the reactive gas;
providing the reaction inducing agent; and
supplying the reactive gas under pressure into the reaction inducing agent through a sparger to generate the at least one encapsulating transport, the encapsulating transport containing at least some of the reactive gas.

12. A method for removing a layer from a substrate surface as recited in claim 8, wherein the generating at least one encapsulating transport further comprising,
providing the reactive gas and the reaction inducing agent; and
agitating the reactive gas and the reaction inducing agent to generate the at least one encapsulating transport, the encapsulating transport containing the at least some of the reactive gas.

13. A method for removing a layer from a substrate surface, comprising:
providing a reactive gas;
providing a reaction inducing agent;
mixing the reactive gas and the reaction inducing agent to generate at least one encapsulating transport, the encapsulating transport containing at least some of the reactive gas; and
applying the at least one encapsulating transport to the layer, the layer being a chemically reactive layer;
wherein the encapsulating transport ruptures on the chemically reactive layer and releases the reactive gas onto the chemically reactive layer to facilitate removal of the layer from the substrate surface.

14. A method for removing a layer from a substrate surface as recited in claim 13, wherein releasing the chemically reactive gas onto the chemically reactive layer places a combination of the reactive gas and the reaction inducing agent in direct contact with the chemically reactive layer.

15. A method for removing a layer from a substrate surface as recited in claim 13, wherein the at least one encapsulating transport is combined with other encapsulating transports to define a foam.

16. A method for removing a layer from a substrate surface as recited in claim 13, wherein the at least one encapsulating transport is a bubble.

17. A method for removing a layer from a substrate surface as recited in claim 13, wherein the chemically reactive layer is an organic material.

18. A method for removing a layer from a substrate surface as recited in claim 13, wherein the reactive gas is one of ozone (O₃), oxygen (O₂), hydrochloric acid (HCl), hydrofluoric acid (HF), nitrogen (N₂), argon (Ar), ozone (O₃) and nitrogen (N₂), ozone (O₃) and argon (Ar), ozone (O₃) and oxygen (O₂) and nitrogen (N₂), ozone (O₃) and oxygen (O₂) and argon (Ar), ozone (O₃) and oxygen (O₂) and nitrogen (N₂) and argon (Ar), oxygen (O₂) and argon (Ar), oxygen (O₂) and nitrogen (N₂), and oxygen (O₂) and argon (Ar) and nitrogen (N₂).

19. A method for removing a layer from a substrate surface as recited in claim 14, wherein the reaction inducing agent is one of water (H₂O), deionized water (DIW), water (H₂O) and a cleaning fluid, water (H₂O) and a surfactant, water (H₂O) and the cleaning fluid and the surfactant, deionized water (DIW) and the cleaning fluid, deionized water (DIW) and the surfactant, and the deionized water (DIW) and the cleaning fluid and the surfactant.

20. An apparatus for removing a layer from a substrate surface, comprising:
an application unit, the application unit configured to receive at least one encapsulating transport, the at least one encapsulating transport containing at least some reactive gas;
wherein the encapsulating transport is capable of being applied to the layer to cause a reaction between the layer and the reactive gas when the encapsulating transport ruptures on the layer.

21. An apparatus for removing a layer from a substrate surface as recited in claim 20, wherein the encapsulating transport is capable of being applied to the layer to cause a reaction between the layer and a combination of the reactive gas and a reaction inducing agent when the encapsulating transport ruptures on the layer.

22. An apparatus for removing a layer from a substrate surface as recited in claim 21, wherein the reaction inducing agent is one of water (H₂O), deionized water (DIW), water (H₂O) and a cleaning fluid, water (H₂O) and a surfactant, water (H₂O) and the cleaning fluid and the surfactant, deionized water (DIW) and the cleaning fluid, deionized water (DIW) and the surfactant, and the deionized water (DIW) and the cleaning fluid and the surfactant.

23. An apparatus for removing a layer from a substrate surface as recited in claim 20, wherein the application unit is a container.

24. An apparatus for removing a layer from a substrate surface as recited in claim 20, wherein the application unit is a proximity head.

25. An apparatus for removing a layer from a substrate surface as recited in claim 20, further comprising, an encapsulating transport generating unit.

26. An apparatus for removing a layer from a substrate surface as recited in claim 20, wherein the reactive gas is one of ozone (O₃), oxygen (O₂), hydrochloric acid (HCl), hydrofluoric acid (HF), nitrogen (N₂), argon (Ar), ozone (O₃) and nitrogen (N₂), ozone (O₃) and argon (Ar), ozone (O₃) and oxygen (O₂) and nitrogen (N₂), ozone (O₃) and oxygen (O₂) and argon (Ar), ozone (O₃) and oxygen (O₂) and nitrogen (N₂) and argon (Ar), oxygen (O₂) and argon (Ar), oxygen (O₂) and nitrogen (N₂), and oxygen (O₂) and argon (Ar) and nitrogen (N₂).

27. An apparatus for removing a layer from a substrate surface as recited in claim 20, wherein the layer is an organic material.

28. An apparatus for removing a layer from a substrate surface as recited in claim 20, wherein the at least one encapsulating transport is combined with other encapsulating transports to define a foam.

29. An apparatus for removing a layer from a substrate surface as recited in claim 20, wherein the at least one encapsulating transport is a bubble.

30. An apparatus for removing a layer from a substrate surface, comprising:
a reactive gas source;
a reaction inducing agent source; and
an application unit, the application unit configured to receive a combination of the reactive gas obtained from the reactive gas source and the reaction inducing agent obtained from the reaction inducing agent source to produce at least one encapsulating transport, the at least one encapsulating transport containing at least some of the reactive gas;
wherein the encapsulating transport is capable of being applied to the layer to cause a reaction between the layer and the reactive gas when the encapsulating transport ruptures on the layer.

31. An apparatus for removing a layer from a substrate surface as recited in claim 30, wherein the encapsulating transport is capable of being applied to the layer to cause a reaction between the layer and a combination of the reactive gas and the reaction inducing agent when the encapsulating transport ruptures on the layer.

32. An apparatus for removing a layer from a substrate surface as recited in claim 31, wherein the reaction inducing agent is one of water (H₂O), deionized water (DIW), water (H₂O) and a cleaning fluid, water (H₂O) and a surfactant, water (H₂O) and the cleaning fluid and the surfactant, deionized water (DIW) and the cleaning fluid, deionized water (DIW) and the surfactant, and the deionized water (DIW) and the cleaning fluid and the surfactant.

33. An apparatus for removing a layer from a substrate surface as recited in claim 30, wherein the application unit is a proximity head.

34. An apparatus for removing a layer from a substrate surface as recited in claim 30, wherein the reactive gas is one of ozone (O₃), oxygen (O₂), hydrochloric acid (HCl), hydrofluoric acid (HF), nitrogen (N₂), argon (Ar), ozone (O₃) and nitrogen (N₂), ozone (O₃) and argon (Ar), ozone (O₃) and oxygen (O₂) and nitrogen (N₂), ozone (O₃) and oxygen (O₂) and argon (Ar), ozone (O₃) and oxygen (O₂) and nitrogen (N₂) and argon (Ar), oxygen (O₂) and argon (Ar), oxygen (O₂) and nitrogen (N₂), and oxygen (O₂) and argon (Ar) and nitrogen (N₂).

35. An apparatus for removing a layer from a substrate surface as recited in claim 30, wherein the layer is an organic material.

36. An apparatus for removing a layer from a substrate surface as recited in claim 30, wherein the at least one encapsulating transport is combined with other encapsulating transports to define a foam.

37. An apparatus for removing a layer from a substrate surface as recited in claim 30, wherein the at least one encapsulating transport is a bubble.
